(19) United States
(12) Patent Application Publication
(10) Pub. No.: US 2015/0334170 A1
(43) Pub. Date: Nov. 19, 2015

(54) USE OF A REMAINDER DURATION AS A BASIS TO GENERATE A PLAYLIST

(71) Applicant: TRIBUNE DIGITAL VENTURES, LLC, Chicago, IL (US)

(72) Inventor: Venkatarama Anilkumar Panguluri, Milpitas, CA (US)

(73) Assignee: TRIBUNE DIGITAL VENTURES, LLC, Chicago, IL (US)

(21) Appl. No.: 14/281,356

(22) Filed: May 19, 2014

(51) Int. Cl. H04L 29/08

(52) U.S. Cl. CPC H04L 67/10

(57) ABSTRACT

An example method includes determining that a resume event occurred. The resume event causes a client device to resume playout of personalized news programming after the client device plays out at least a portion of a first personalized news program. The method further includes, in response to determining that the resume event occurred, determining a remainder duration representing a duration of the first personalized news program less an elapsed duration between (i) a start time when the client device initiated playout of the first personalized news program and (ii) a resume time when the resume event occurred. The method further includes using the determined remainder duration to generate a playlist of a second personalized news program having a duration that is less than the duration of the first personalized news program. The method further includes transmitting the generated playlist to the client device.

### USAGE AND TERMINOLOGY

In this disclosure, unless otherwise specified and/or unless the particular context clearly dictates otherwise, each usage of “a” or “an” means at least one, and each usage of “the” means the at least one.

### TECHNICAL FIELD

This disclosure relates generally to computing devices, and more particularly, to computing devices configured for providing media content such as personalized news programs for instance.

### BACKGROUND

Unless otherwise indicated herein, the materials described in this section are not prior art to the claims in this disclosure and are not admitted to be prior art by inclusion in this section.

To listen to the radio, a listener typically tunes a receiver to a particular frequency (e.g., an AM or FM frequency) and listens to music, news, or other audible content being broadcast on that frequency by a radio station. The listener may tune the receiver, and therefore select a radio station, in a variety of ways, such as by rotating a dial, pushing a seek button, or pushing a station preset button. By selecting one of multiple radio stations, the listener may exert some control over the audible content presented to the listener. However, although the listener may control which station is selected, the listener is unlikely to have any influence over the audible content that gets broadcast by the selected station.

Typically, a radio station broadcasts the same audible content to multiple receivers, and therefore to multiple listeners, at the same time. Given this, it is common for a radio station to produce and broadcast audible content that is intended to appeal to a variety of different listeners. However, while some listeners may find such audible content appealing, other listeners may find it unappealing because it is not tailored to their particular interests.

### SUMMARY

In one aspect, an example method includes determining that a resume event occurred. The resume event causes a client device to resume playout of personalized news programming after the client device plays out at least a portion of a first personalized news program. The method further includes, in response to determining that the resume event occurred, determining a remainder duration representing a duration of the first personalized news program less an elapsed duration between (i) a start time when the client initiated playout of the first personalized news program and (ii) a resume time when the resume event occurred. The method further includes using the determined remainder duration to generate a playlist of a second personalized news program having a duration that is less than the duration of the first personalized news program. The method further includes transmitting the generated playlist to the client device.

In another aspect, an example server device includes a processor, a communication interface, and a non-transitory computer-readable storage medium having stored thereon instructions that when executed by the processor cause the server device to perform functions. The functions include determining that a resume event occurred. The resume event causes a client device to resume playout of personalized news programming after the client device plays out at least a portion of a first personalized news program. The functions further include, in response to determining that the resume event occurred, determining a remainder duration representing a duration of the first personalized news program less an elapsed duration between (i) a start time when the client device initiated playout of the first personalized news program and (ii) a resume time when the resume event occurred. The functions further include using the determined remainder duration to generate a playlist of a second personalized news program having a duration that is less than the duration of the first personalized news program. The functions further include transmitting, via the communication interface, the generated playlist to the client device.

In another aspect, an example non-transitory computer-readable storage medium has stored thereon program instructions that when executed by a processor cause performance of functions. The functions include determining that a resume event occurred. The resume event causes a client device to resume playout of personalized news programming after the client device plays out at least a portion of a first personalized news program. The functions further include, in response to determining that the resume event occurred, determining a remainder duration representing a duration of the first personalized news program less an elapsed duration between (i) a start time when the client device initiated playout of the first personalized news program and (ii) a resume time when the resume event occurred. The functions further include using the determined remainder duration to generate a playlist of a second personalized news program having a duration that is less than the duration of the first personalized news program. The functions further include transmitting the generated playlist to the client device.

These, as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1 is a simplified block diagram of an example system;

FIG. 2 is a flow chart depicting functions of an example method;

FIG. 3 is a diagram of an example playlist template;

FIG. 4 is a diagram of an example playlist;

FIG. 5 is a flow chart depicting functions of another example method;

FIG. 6 is a flow chart depicting functions of another example method.

### DETAILED DESCRIPTION

### I. Overview

As indicated above, a radio station may produce and broadcast audible content that is intended to appeal to a variety of different listeners. For example, in the context of producing and broadcasting a news program, a narrator (such as a news anchor affiliated with the radio station, or another person) may read aloud news stories from each of a variety of different predetermined categories, such as sports, politics, and entertainment, and the readings may be included as part of the news program.

Although some listeners may be interested in audible versions of news stories from all of the predetermined categories, other listeners may have different interests. For example, one listener may be interested in sports and entertainment, but not politics, while another listener may be interested in politics and entertainment, but not sports. In either case, the listener may be presented with audible content that does not align with the listener's interests. As a result, the listener may find the news program unappealing.

One way to help address this issue is by implementing a system that provides a user with a personalized news program. In one aspect, such a system may include at least two computing devices, such as a server and a client, and a communication network through which the server and the client may communicate.

In this system, the server and the client may perform a variety of functions. For example, the server may determine a set of attributes associated with a user of the client and may use the determined set of attributes as a basis to generate a playlist of a personalized news program for the user. The generated playlist may define a sequence of media content items, each of which may include audible content such as an audible version of a news story. An audible version of a news story may be referred to herein as an “audible news story.” The generated playlist may also specify media content attribute data respectively for each media content item, including for instance a reference to data representing the media content item and metadata characterizing the media content item. Collectively, this sequence of media content items may thus define a personalized news program for playout to the user.

After or as the server generates this playlist, the server may transmit the playlist to the client, and the client may traverse the entries of the playlist, retrieve data representing each referenced media content item, and use the data to play out each referenced media content item in accordance with the sequence defined by the playlist. In practice, for instance, for each media content item of the sequence, (i) the client may transmit to the server, or to another server for that matter, a request for data representing the media content item, (ii) the server may receive the transmitted request, (iii) responsive to the server receiving the transmitted request, the server may transmit to the client, the requested data, (iv) the client may receive the transmitted data, and (v) the client may play out for the user the media content item represented by the received data.

Optimally, this process may involve streaming of the data representing the media content items to the client and playout of the sequence of media content items in real time by the client. In particular, for each media content item referenced by the playlist, the client may request a server to stream the data representing the media content item to the client, and the client may then receive in response a data stream defining the requested media content item. As the client receives and buffers the requested data representing the media content items in sequence, the client may then play out the represented media content items to a user, thus providing the user with a substantially continuous playout of the media content items defining the personalized news program.

Another way to help render a news program more appealing to a user is to personalize the news program to the user based on the user's anticipated travel duration. This may involve the server determining an anticipated travel duration of a user of the client based on the user's current location, the user's travel history, or real-time traffic conditions. The server may then use the determined anticipated travel duration of the user as a basis to generate a playlist of a personalized news program for the user. By way of illustration, a user's anticipated travel duration may represent an anticipated time allotted for the user's commute between home and work. For example, the server may generate the playlist by selecting a plurality of audible news stories to be represented in the playlist such that an overall duration of the selected plurality of news stories does not exceed, or is within a threshold range of, the determined anticipated travel duration. After or as the server generates this playlist, the server may transmit the playlist to the client such that the client may play out each referenced audible news story as described above.

However, playout of the first personalized news program by the client may be paused in response to a variety of pause events, such as the client (i) receiving user input requesting that playout be paused, (ii) receiving an incoming phone call, (iii) losing network connectivity, or (iv) closing a software application. For example, a telephony application running on the client may detect that the telephony application is receiving an incoming phone call and transmit a request to pause playout to an application facilitating playout of the first personalized news program or to an operating system running on the client.

After playout of the first personalized news program is paused, the client may resume playout in response to a resume event, such as the client (i) receiving user input requesting that playout be resumed, (ii) ending an incoming call, (iii) (re)establishing network connectivity, or (iv) opening a software application.

One way to resume playout would be to resume playout of the first personalized news program at a point at which playout of the first personalized news program would have reached but for being paused by the client. This may cause the user to miss programming that was “skipped” by the client. Or, the client could resume playout of the first personalized news program at a point at which the pause event occurred. In this scenario, the user may reach his or her travel destination before resumed playout of the first personalized news program can be completed, causing the user to miss content at the end of the first personalized news program. Thus, the time that passes while playout of the first personalized news program is paused may make it impossible to resume and complete playout of the first personalized news program within the constraints of the user's travel duration, because a duration of the first personalized news program that remains to be played out may exceed a remaining travel duration of the user (i.e. a remainder duration). This may diminish the user's experience.

The disclosed system and method may help address this issue. In one example, a server may determine that a resume event has occurred and, in response, the server may determine a remainder duration that represents a duration of the first personalized news program less an elapsed duration between (i) a start time when the client initiated playout of the first personalized news program and (ii) a resume time when the resume event occurred. The server may then use the determined remainder duration to generate a playlist representing a second personalized news program to be played out by the client. The second personalized news program, like the first personalized news program, may be customized based on attributes or interests of the user, but may have a duration shorter than the first personalized news program that allows complete playout of the second personalized news program during the user's remaining travel time. Lastly, the server may transmit the playlist to the client.

The server may determine the remainder duration in a variety of ways. For example, the server may receive from the client timestamp information pertaining to various times such as when playout of the first personalized news program by the client was initialized, when the pause event occurred, and when the resume event occurred. Or, the server may receive duration information such as a duration during which the first personalized news program was played out (i.e. a playout duration), a pause duration between (i) the pause time corresponding to the pause event and (ii) the resume time, or a duration representing an amount of time between (i) initialization of playout by the client and (ii) the resume event. The server may determine the remainder duration in a number of different ways using the received timestamp or duration information.

### II. Example System

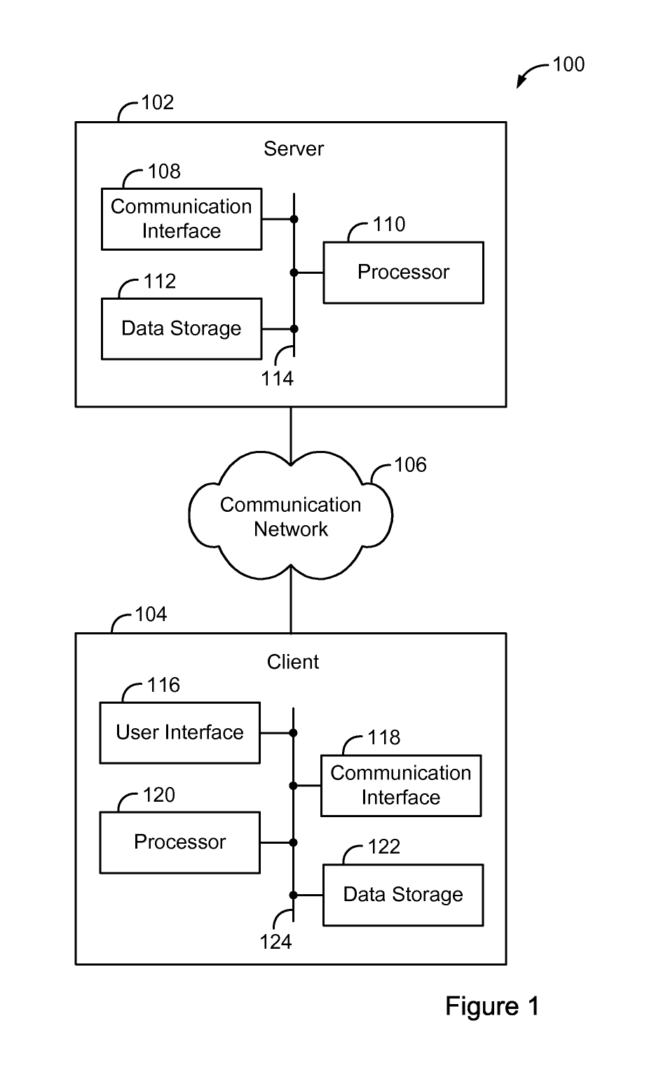

FIG. 1 is a simplified block diagram of an example system 100 in which aspects of the present disclosure can be implemented. As shown, the system 100 includes at least two computing devices, namely a server 102 and a client 104, and a communication network 106. Generally, the server 102 and the client 104 are configured for communicating with each other via the communication network 106.

A. Server

The server 102 may be configured for performing a variety of functions, such as those described in this disclosure (including the accompanying drawings). For example, the server 102 may be configured for establishing and transmitting to the client 104 a playlist defining a sequence of media content items that may define a personalized news program for instance, and for streaming data representing various media content items to the client 104 via the communication network 106 such that the client 104 may playout the represented media content items.

The server 102 may take a variety of forms and may include various components, including for example, a communication interface 108, a processor 110, and a data storage 112, all of which may be communicatively linked to each other via a system bus, network, or other connection mechanism 114.

The communication interface 108 may take a variety of forms and may be configured to allow the server 102 to communicate with one or more devices according to any number of protocols. For instance, the communication interface 108 may be configured to allow the server 102 to communicate with the client 104 via the communication network 106. In one example, the communication interface 108 may take the form of a wired interface, such as an Ethernet interface. As another example, the communication interface 108 may take the form of a wireless interface, such as a cellular or WI-FI interface.

The processor 110 may include a general purpose processor (e.g., a microprocessor) and/or a special purpose processor (e.g., a digital signal processors (DSP)).

The data storage 112 may include one or more volatile, non-volatile, removable, and/or non-removable storage components, such as magnetic, optical, or flash storage, and may be integrated in whole or in part with the processor 110. Further, the data storage 112 may take the form of a non-transitory computer-readable storage medium, having stored thereon program instructions (e.g., compiled or non-compiled program logic and/or machine code) that, when executed by the processor 110, cause the server 102 to perform one or more functions, such as those described in this disclosure.

B. Client

Likewise, the client 104 may be configured for performing a variety of functions such as those described in this disclosure. For example, the client 104 may be configured for receiving from the server 102 a playlist defining a sequence of media content items to be played out by the client, traversing the entries of the playlist, retrieving the data representing each referenced media content item, and using the retrieved data to play out each referenced media content item in accordance with the sequence defined by the playlist

The client 104 may take a variety of forms, including for example, a mobile phone, tablet, laptop, media player, gaming device, wearable device, or vehicle. And the client 104 may include various components, including for example, a user interface 116, a communication interface 118, a processor 120, and a data storage 122, all of which may be communicatively linked with each other via a system bus, network, or other connection mechanism 124.

The user interface 116 may be configured for facilitating interaction between the client 104 and a user of the client 104, such as by receiving input from the user and providing output to the user. Thus, the user interface 116 may include input components such as a computer mouse, a keyboard, or a touch-sensitive panel. In addition, the user interface 116 may include output components such as a display screen (which, for example, may be combined with a touch-sensitive panel) and a sound speaker or other audio output mechanism. Furthermore, the user interface 116 may include a digital-analog conversion unit to facilitate playout of media content to a user.

The communication interface 118 may take a variety of forms and may be configured to allow the client 104 to communicate with one or more devices according to any number of protocols. For instance, the communication interface 118 may be configured to allow the client 104 to communicate with the server 102 via the communication network 106. Further, the communication interface 118 may take the form of a wired or wireless interface.

The processor 120 may include a general purpose processor and/or a special purpose processor. The data storage 122 may include one or more volatile, non-volatile, removable, and/or non-removable storage components, and may be integrated in whole or in part with the processor 120. Further, the data storage 122 may take the form of a non-transitory computer-readable storage medium, having stored thereon program instructions that, when executed by the processor 120, cause the client 104 to perform one or more functions, such as those described in this disclosure. Such program instructions may define or be part of a discrete software application, such a native app or web app, that can be executed upon user request for instance.

C. Communication Network

Generally, the communication network 106 may be configured to allow the server 102 and the client 104 to communicate with each other using any number of protocols. In addition, the communication network 106 may take a variety of forms, including for example a packet-switched network such as the Internet.

### III. Example Operations

Methods of this disclosure will now be described principally in connection with providing a personalized news program to a user of the client 104. It will be understood, however, that this disclosure can extend to apply with respect to providing other types of media content as well, not necessarily limited to personalized news programs.

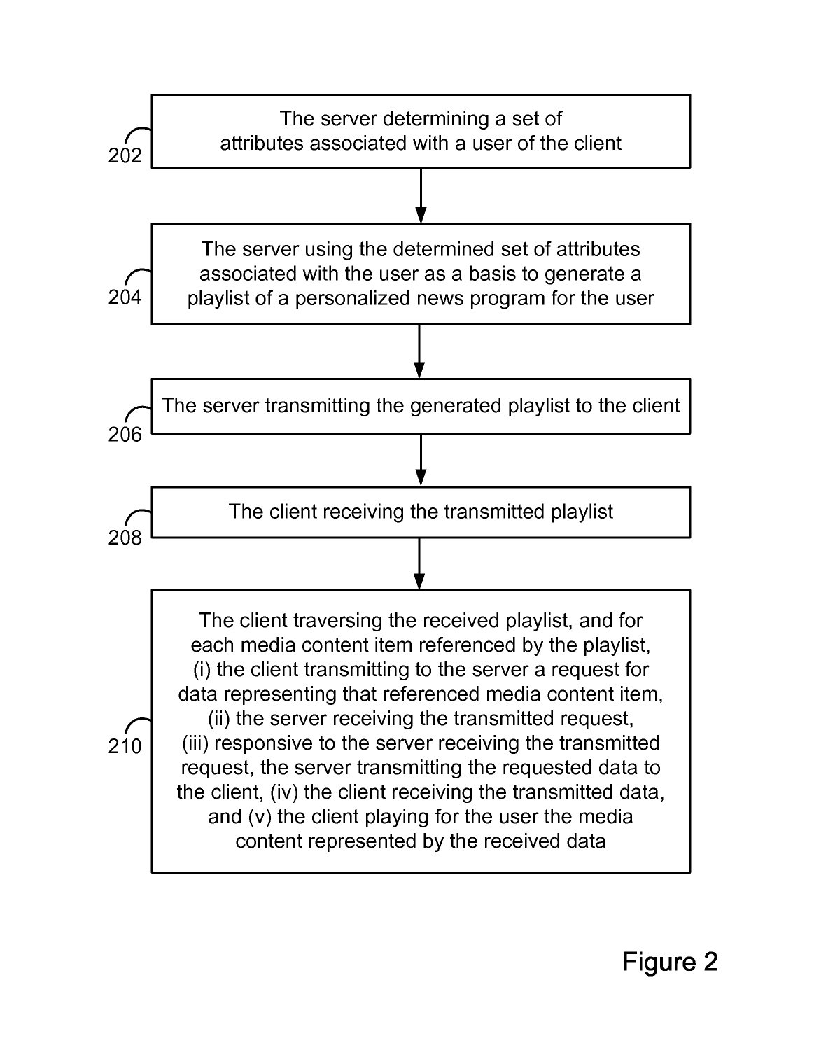

FIG. 2 is a flow chart depicting functions that can be carried out in an example method for providing a user of the client 104 with a personalized news program. At block 202, the example method involves the server 102 determining a set of (i.e., one or more) attributes associated with a user of the client 104. At block 204, the method then involves the server 102 using the determined set of attributes as a basis to generate a playlist of a personalized news program for the user. At block 206, the method then involves the server 102 transmitting the generated playlist to the client 104, and at block 208, the method involves the client 104 receiving the transmitted playlist. At block 210, the method then involves the client 104 traversing the received playlist, and for each media content item referenced by the playlist, (i) the client transmitting to the server a request for data representing that referenced media content item, (ii) the server receiving the transmitted request, (iii) responsive to the server receiving the transmitted request, the server transmitting the requested data to the client, (iv) the client receiving the transmitted data, and (v) the client playing for the user the media content item represented by the received data.

In this process, each user-associated attribute that the server 102 determines may take various forms. By way of example, each attribute may relate to one or more of the following: the user's extent of interest in a particular type of news story, the user's interest in a particular type of audible news story, whether the user has a subscription to a news-related product or service (e.g., a newspaper subscription), the user's age, the user's gender, the user's current location, the user's destined location (e.g., a location to which the user is driving), the weather at the user's current location, the weather at the user's destined location, and the user's estimated travel time between the user's current location and the user's destined location.

Further, the function of the server 102 determining the set of attributes associated with the user may take various forms. In one example implementation, for instance, the server 102 may receive from the client 104 an identification of the user of the client 104, and the server 102 may then refer to one or more data sources that correlate or facilitate correlation of that identification with an attribute, so as to determine an attribute associated with the user. And in another example implementation, the client 104 itself may determine a user-associated attribute and may report the determined attribute to the server 102, in which case the server would determine the user-associated attribute by receiving the reported attribute from the client 104. To facilitate this, the client 104 may provide a configuration interface through which the user can manually enter or select a user-associated attribute, and the client 104 may thus determine the user-associated attribute by receiving user indications of the user-associated attribute through that interface. Alternatively or additionally, the client 104 may determine a user-associated attribute by evaluating information associated with the user, such as user profile records, browsing history, shopping history, location history and the like. Other examples are possible as well.

For this purpose, the client 104 may determine the attribute associated with the user in a variety of ways. As one example, the client 104 may receive the attribute as input from the user. As another example, the client 104 may receive other input from the user, and the client 104 may use the input as a basis to determine the attribute. For instance, the client 104 may receive input from the user, such as the user's destined location, and the client 104 may use a positioning device and a navigation software application to determine the user's estimated travel time from the user's current location to the user's destined location. In some instances, the client may communicate with the server 102 or another server, such as a server affiliated with the mapping application, to determine such an attribute. Other example techniques for determining an attribute associated with a user are possible as well.

The server 102 may then use the determined set of attributes associated with the user in various ways to generate the playlist of the personalized news program for the user. For instance, based on the set of user-associated attributes, the server 102 may select particular audible news stories or types of audible news stories to specify as media content items in the playlist. As such, the server 102 may be configured with data that maps particular sets of user-associated attributes with particular types of audible news stories, possibly giving more weight to inclusion of certain types of audible news stories than to other types of audible news stories. For example, the data may indicate that a particular set of user-associated attributes suggests more likely user interest in entertainment news than in politics news, in which case the server 102 may structure the playlist to specify a greater extent of entertainment-related audible news stories than politics-related audible news stories. As another example, the data may indicate that a particular set of user-associated attributes suggests great user interest in sports, in which case the server 102 may structure the playlist to specify a relatively great extent of sports-related audible news stories.

In some examples, an audible news story's type may be defined by a set of attributes associated with the audible news story, examples of which may include or relate to one or more of the following: the audible news story's category, the audible news story's target demographic (e.g., by age, gender, or location), the audible news story's creation date, the audible news story's author or other attribution information, the extent of popularity of the audible news story, the extent of popularity of a person or topic related to the audible news story, or the manner in which data representing the audible news story was generated.

These attributes may be stored in a variety of ways. For example, they may be stored as metadata along with the data representing the audible news story to which they correspond. These attributes may also be set in a variety of different ways, such as by a user via a user interface.

As indicated above, a media content item such as an audible news story may be represented by data. This data may be generated in a variety of ways. For example, the server 102 may generate data representing an audible news story by recording a narrator reading aloud a text-based version of the news story, or by using a well-known TTS software and/or hardware system to convert data representing a text-based version of a news story into data representing an audible version of the news story. Further, data representing a media content item may be stored in a variety of ways. For example, the data may be stored in the form of a digital audio file in a data storage, such as the data storage 112.

In one implementation, the function of the server 102 using the determined set of attributes associated with the user as a basis to generate a playlist of a personalized news program for the user may involve the server 102 (i) using the determined set of attributes associated with the user as a basis to select a playlist template from a group of templates (e.g., stored in the data storage 112), (ii) using the selected playlist template as a basis to select a set of audible news stories from a group of audible news stories (e.g., stored in the data storage 112), and (iii) generating a playlist that includes references to each audible news story from the selected set of audible news stories.

Generally, a playlist template serves as an outline for a playlist and may define a sequence of placeholders for media content attribute data and/or media content attribute data itself. For each placeholder, the playlist template may further specify placeholder attribute data. Based on this placeholder attribute data, the server 102 may select a set of audible news stories, and replace that placeholder with media content attribute data for the selected set of audible news stories, thereby converting the playlist template into a playlist.

There may be a variety of different types of placeholder attribute data, examples of which may include a quantity tag and a type tag. A quantity tag specifies a quantity of audible news stories that the server 102 should select for the corresponding placeholder. And the type tag specifies the particular types of audible news stories that the server 102 should select for the corresponding placeholder.

As indicated above, a playlist template may define a sequence of placeholders for media content attribute data and/or media content attribute data itself. In the case where the sequence defines media content attribute data, the server 102 may “carry though” the media content attribute data from the playlist template to the playlist as the server 102 generates the playlist.

In line with the discussion above, the playlist that the server 102 generates may define an ordered sequence of entries, each of which provides media content attribute data regarding a respective media content item, such as a particular audible news story. In practice, the playlist may provide this information in various ways, such as with use of extensible markup language (XML) for instance, in a manner that the client 104 would be configured to read.

For a given media content item, the media content attribute data may include a reference to the data representing the media content item, such as a network address or content identifier that the client 104 can read and use as a basis to request and receive the data representing the media content item for playout of the represented media content item. Thus, the client 104 may read the reference indicated for a given media content item to determine a network address or the like from which to obtain the data representing the media content item, and the client 104 may request and receive the data representing the media content item from that network address or by otherwise using the indicated reference.

Such a reference may have various levels of granularity. By way of example, the reference may be specific to data representing a particular audible news story, by specifying a particular story identifier or name of a news story media file for instance, in which case the client 104 could request the server 102 to transmit that data representing that particular audible news story and the server 102 could retrieve that data representing that particular audible news story from data storage and transmit it to the client 104. And as another example, the reference may be more general, specifying a class of news story, such as “traffic” or “weather” for instance, in which case the client 104 could request the server 102 to transmit data representing an audible news story of that class generally, and the server 102 may then retrieve data representing a latest or most pertinent audible news story of that class and transmit it to the client 104. Further, any or all of these references may refer to locations other than server 102, such as to one or more other servers for instance.

Further, the server 102 may transmit the generated playlist to the client 104, and the client 104 may receive the generated playlist, in various ways. By way of example, the client 104 may transmit to the server 102 a hypertext transfer protocol (HTTP) request or the like seeking the playlist, and the server 102 may respond by generating the playlist and transmitting the playlist to the client 104 in an HTTP response or the like.

Continuing with reference to FIG. 2, as noted above, at block 210, the method involves the client 104 traversing the received playlist, and for each media content item of the sequence, (i) the client transmitting to the server, a request for data representing the media content item, (ii) the server receiving the transmitted request, (iii) responsive to the server receiving the transmitted request, the server transmitting to the client, the requested data, (iv) the client receiving the transmitted data, and (v) the client playing out for the user the media content item represented by the received data.

As further noted above, this process may involve streaming of the data representing the media content item from the server 102, or from one or more other servers, to the client 104. In practice, for instance, as the client 104 traverses the playlist, the client 104 may read each successive entry to determine the reference that the entry specifies for a media content item, and the client may transmit to the server 102 a request for the server 102 to stream the data representing that media content item to the client 104. To facilitate this, the client 104 may engage in signaling with the server 102 in accordance with the Real Time Streaming Protocol (RTSP), to establish a streaming media session and to specify the data representing the media content to be streamed, and the server 102 may stream the requested data to the client 104 in accordance with the Real-time Transport Protocol (RTP). As the client 104 receives this streamed data, the client 104 may then buffer and play out the content represented by the data in real time, providing the user with substantially continuous playout of the news program.

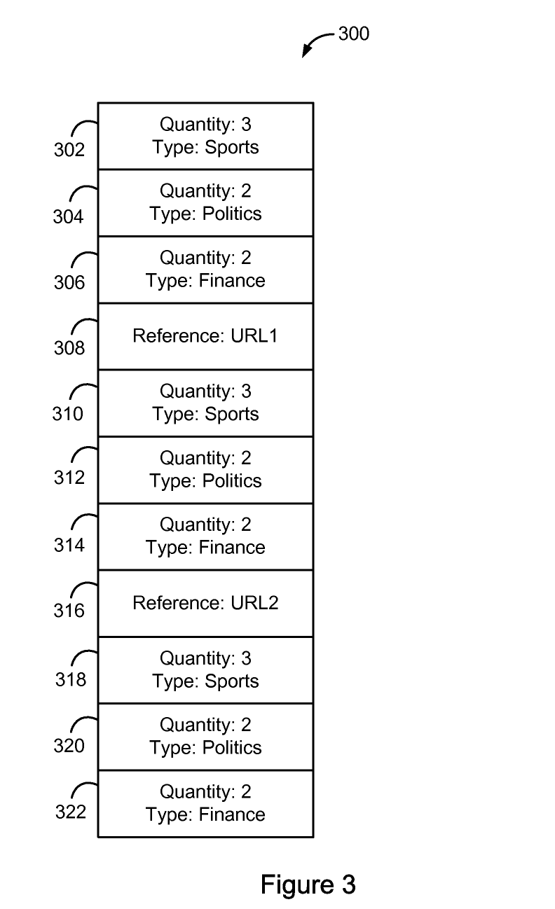

To help appreciate operation of this process, FIG. 3 shows an example playlist template 300. The template 300 includes eleven ordered entries 302-322 (even numbers only). Each of the entries 302, 304, 306, 310, 312, 314, 318, 320, and 322 serves as a placeholder for media content attribute data. And each of those entries includes placeholder attribute data, namely a quantity tag and a type tag. For example, the entry 302 includes a quantity tag that specifies “3” and a type tag that specifies a “Sports” category type. As another example, the entry 304 includes a quantity tag that specifies “2” and a type tag that specifies a “Politics” category type. Further, each of the entries 308 and 316 include media content attribute data. In particular, the entry 308 includes the reference “URL1” and the entry 316 includes the reference “URL2.”

As indicated above, at block 204, the method may involve the server 102 using the selected playlist template as a basis to select a set of audible news stories from a group of audible news stories (e.g., stored in the data storage 112). This may involve, for each entry that serves as a placeholder of media content attribute data, the server 102 using the quantity and type tags of that entry as a basis to select a set of audible news stories. For example, for the entry 302, the server 102 may select a set of 3 audible news stories that are all associated with a sports category attribute. As another example, for the entry 304, the server 102 may select a set of 2 audible news stories that are all associated with a politics category attribute.

Additionally or alternatively, the server 102 may determine an attribute associated with an audible news story, and the server 102 may use the determined attribute as a basis to select the set of audible news stories from the group of audible news stories.

As noted above, block 204 may involve generating a playlist that includes references to each audible news story from the selected set of audible news stories. This may involve the server 102 replacing placeholders of the playlist template with the appropriate selected sets of audible news stories, and thereby generating a playlist by “converting” the playlist template into a playlist.

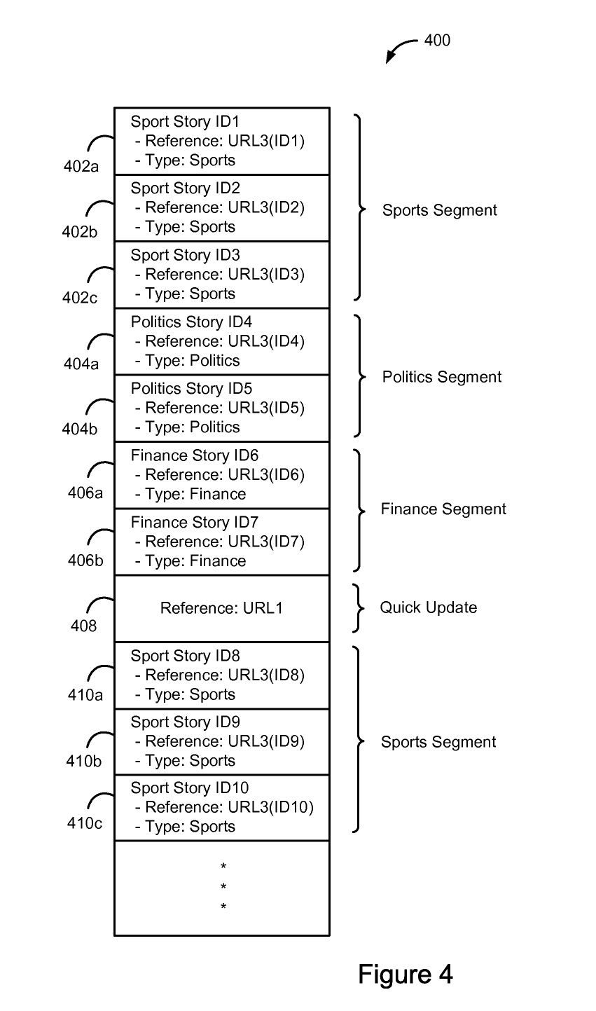

FIG. 4 shows a portion of an example playlist 400 that the server 102 may generate after the server 102 selects the playlist template 300. As shown, the generated playlist 400 include entries 402a-c, 404a-b, 406a-b, and 410a-c, each of which is for a respective audible news story and designates a respective reference and category type. For example, entry 402a designates a “Sports Story ID1,” with a reference in the form of “URL3” that may point to the server 102 and that designates “ID1” as a query parameter or the like, and with a category type indication of “Sports.” Entry 402b then designates a “Sports Story ID2,” with a reference in the form of “URL3” that may point to the server 102 and that designates “ID2” as a query parameter, and with a category type indication of “Sports.” And entry 402c designates a “Sports Story ID3,” with a reference in the form of “URL3” that may point to the server 102 and that designates “ID3” as a query parameter, and with a category type indication of “Sports.” As shown, this portion of the playlist 400 may be referred to as the “Sports Segment.”

As another example, entry 404a designates a “Politics Story ID4,” with a reference in the form of “URL3” that may point to the server 102 and that designates “ID4” as a query parameter, and with a category type indication of “Politics.” And entry 404b designates a “Politics Story ID5,” with a reference in the form of “URL3” that may point to the server 102 and that designates “ID5” as a query parameter, and with a category type indication of “Politics.” As shown, this portion of the playlist 400 may be referred to as the “Politics Segment.”

Since the entry 308 of the playlist template 300 included media content attribute data, namely the reference URL1, the server 102 may “carry though” the media content attribute data from the playlist template 300 to the playlist 400 as the server 102 generates the playlist 400. Accordingly, the entry 408 indicates the reference “URL1.” As shown, this portion of the personalized news program may be referred to as a “quick update.” In one example, a quick update may provide relatively small portions of data-centric information (e.g., traffic or weather information) to break up two segments in the personalized news program.

For brevity, FIG. 4 does not show additional entries after 410c, but it should be apparent that the server 102 may generate the remainder of the playlist 400 using the techniques described above.

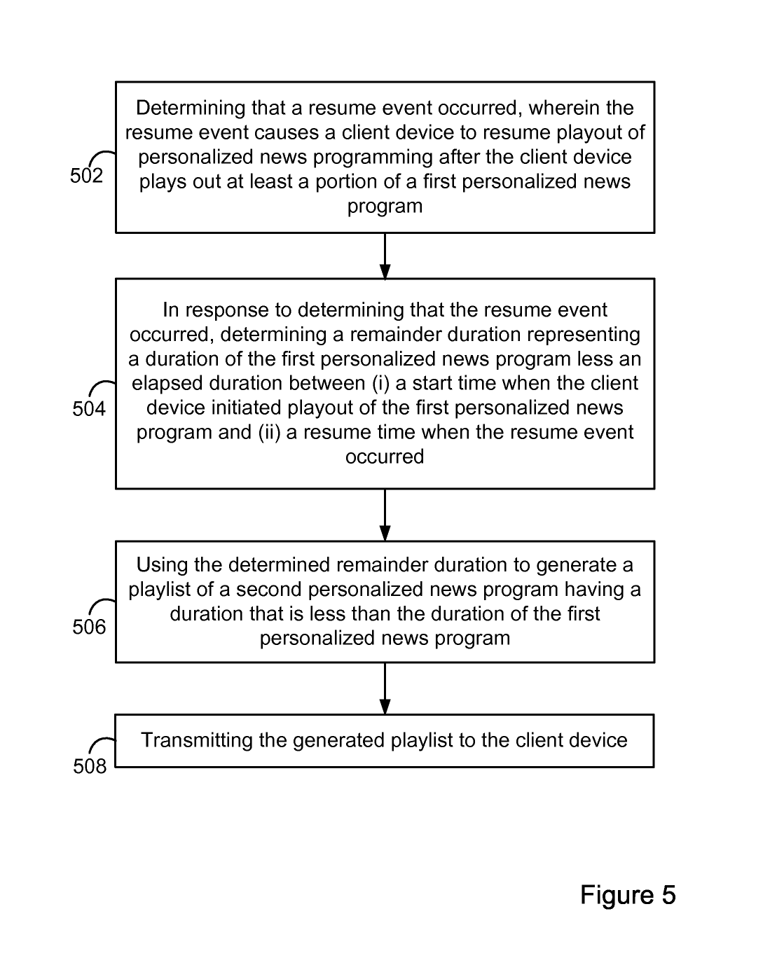

FIG. 5 is a flow chart depicting functions that can be carried out in another example method for providing a user of the client 104 with a personalized news program.

At block 502, the example method involves the server 102 determining that a resume event occurred. The resume event causes the client 104 to resume playout of personalized news programming after the client 104 plays out at least a portion of a first personalized news program. The resume event occurs subsequent to a corresponding pause event.

For example, the client 104 may pause playout of the first personalized news program responsive to pause events such as (i) receiving via a user interface an input from the user, (ii) receiving an incoming call, (iii) losing network connectivity, or (iv) closing a software application. For instance, the user may provide input to the client 104 indicating to provide additional information (e.g. a webpage that includes text, audio, or video content) regarding an audible news story that is being played out by the client 104. The user may also provide input that explicitly indicates to pause playout, for example, so that the user may converse with a friend. The client 104 may also automatically pause playout if the client 104 receives an incoming call, such as a conventional phone call or a video chat request. Further, the client 104 may automatically pause playout if the client 104 loses a wired or wireless connection to the communication network 106, or if the client 104 malfunctions or “crashes.” Also, the client 104 may pause playout if the user provides input indicating to close a media playback application playing out the first personalized news program. The pause event may generally include the client 104 executing any program instruction that causes the client 104 to pause playout of the first personalized news program. Other examples are possible.

The resume event may include (i) receiving an input from the user, (ii) ending an incoming call, (iii) establishing network connectivity, or (iv) opening a software application. For example, the user may provide input to the client 104 indicating that playout of personalized news programming should resume, perhaps because a distraction that caused the user to pause playout has ended. The client 104 may also automatically resume playout responsive to the end of a call being facilitated by the client 104, or upon the client 104 regaining a lost wired or wireless connection to the communication network 106. The client 104 may also resume playout upon the user opening a media playout application configured to playout the first personalized news program. The resume event may generally occur after the client 104 plays out at least a portion of a first personalized news program. The resume event may include the client 104 executing a program instruction that causes the client 104 to resume playout of personalized news content.

The server 102 may determine that the resume event occurred by receiving data indicating that the resume event occurred. The data may be received from the client 104, via the communication network 106.

In some cases, the method may further include the server 102 transmitting to the client 104 a playlist of the first personalized news program that the client 104 may use to playout the first personalized news program.

At block 504, the method includes, in response to determining that the resume event occurred, determining a remainder duration representing a duration of the first personalized news program less an elapsed duration between (i) a start time when the client 104 initiated playout of the first personalized news program and (ii) a resume time when the resume event occurred.

In one example, the server 102 may determine the duration of the first personalized news program, perhaps by receiving, from the client 104 or data storage 112, data indicating the duration of the first personalized news program. For example, the server 102 may receive data indicating the duration of the first personalized news program to be 45 minutes. Also, the server 102 may determine the elapsed duration by receiving data indicating that the elapsed duration is 20 minutes. The server 102 may then determine the remainder duration as a difference between the duration of the first personalized news program and the elapsed duration (e.g., 45 minutes−20 minutes=25 minutes). The server 102 or the client 104 may collect such duration or timestamp data as news programming playlists are generated or transmitted, or at other times. Such data may include, but is not limited to, a start time, a pause time, a resume time, a scheduled end time, a playout duration, a pause duration, and a duration, all of or in connection with the first personalized news program.

In another example, the server 102 may determine the duration of the first personalized news program using techniques similar to those mentioned above. In one example, the server 102 may determine a pause duration between the resume time and a pause time corresponding to a pause event that causes the client 104 to pause playout of the first personalized news program. For example, the duration of the first personalized news program may be 60 minutes and the server 102 may receive data indicating a pause duration of 20 minutes. Next, the server 102 may determine a playout duration between the start time and the pause time. For example, the server 102 may receive data indicating a playout duration of 25 minutes. Finally, the server 102 may determine the remainder duration as the duration of the first personalized news program less a sum of (i) the determined playout duration and (ii) the determined pause duration. In this example, the remainder duration is 15 minutes (i.e., 60 minutes−(25 minutes+20 minutes)=15 minutes).

In yet another example, the server 102 may first determine the start time and the resume time. For instance, the server 102 may receive data indicating a start time of 1:00 PM and a resume time of 1:25 PM. The server 102 may also receive data indicating a scheduled end time representing a time when playout of the first personalized news program by the client 104 may have completed but for the client 104 pausing the playout. For example, the server 102 may determine (perhaps via received data from the client 104) the end time to be to be 1:50 PM. The server 102 may then determine the duration of the first personalized news program as a difference between the end time and the start time (i.e., 1:50 PM-1:00 PM=50 minutes). Next, the server 102 may determine the elapsed duration as a difference between the determined resume time and the determined start time (i.e., 1:25 PM-1:00 PM=25 minutes). Lastly, the server 102 may determine the remainder duration as a difference between the duration of the first personalized news program and the elapsed duration (i.e. 50 minutes−25 minutes=25 minutes).

In another example, the server 102 may determine the start time, the pause time, and the resume time. For instance, the server 102 may receive data indicating a start time of 2:00 PM, a pause time of 2:15 PM, and a resume time of 2:35 PM. The server 102 may then determine an end time of the first personalized news program when playout of the first personalized news program by the client 104 may have completed but for the client 104 pausing the playout. In this example, the server 102 may receive data indicating an end time of 3:00 PM. The server may next determine the duration of the first personalized news program as a difference between the end time and the start time (i.e. 3:00 PM-2:00 PM=60 minutes). Also, the server 102 may determine the playout duration as a difference between the pause time and the start time (i.e. 2:15 PM-2:00 PM=15 minutes). Further, the server 102 may determine the pause duration as a difference between the resume time and the pause time (i.e. 2:35 PM-2:15 PM=20 minutes). Lastly, the server 102 may determine the remainder duration as the duration of the first personalized news program less a sum of (i) the determined playout duration and (ii) the determined pause duration (i.e., 60 minutes−(15 minutes+20 minutes)=25 minutes). Other examples are possible.

Further, at block 506, the method then involves the server 102 using the determined remainder duration to generate a playlist of a second personalized news program having a duration that is less than the duration of the first personalized news program. For example, the server 102 may generate the playlist of the second personalized news program so that the duration of the second personalized news program (i.e., the cumulative duration of the media content items of the second personalized news program) is shorter than or equal to the determined remainder duration.

At block 508, the method involves transmitting the generated playlist to the client 104. For example, the server 102 may transmit the generated playlist via the communication interface 108 and the communication network 106.

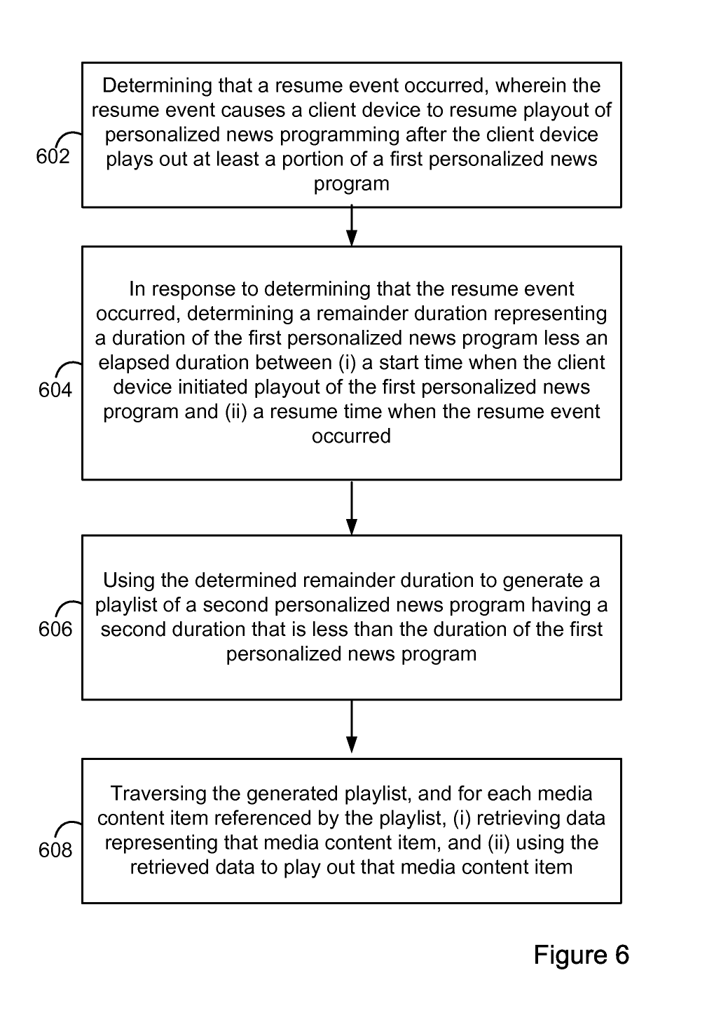

FIG. 6 is a flow chart depicting functions that can be carried out in another example method in connection with a personalized news program.

At block 602, the example method involves the client 104 determining that a resume event occurred, wherein the resume event causes the client to resume playout of personalized news programming after the client 104 plays out at least a portion of a first personalized news program. At block 604, the example method involves, in response to the client 104 determining that the resume event occurred, determining a remainder duration representing a duration of the first personalized news program less an elapsed duration between (i) a start time when the client initiated playout of the first personalized news program and (ii) a resume time when the resume event occurred. At block 606, the method involves using the determined remainder duration to generate a playlist of a second personalized news program having a duration that is less than the duration of the first personalized news program. At block 608, the example method involves the client 104 traversing the generated playlist, and for each media content item referenced by the playlist, the client 104 (i) retrieving data representing that media content item, and (ii) using the retrieved data to play out that media content item.

### IV. Example Variations

The variations described in connection with select examples of the disclosed system and method may be applied to all other examples of the disclosed system and method.

Further, while one or more functions have been described as being performed by or otherwise related to certain devices or entities (e.g., the server 102 or the client 104), the functions may be performed by or otherwise related to any device or entity. As such, any function that has been described as being performed by the server 102 could alternatively be performed by a different server or by the client 104. For instance, in one example, a one server could generate and transmit a playlist to a client, and based on the playlist data of the playlist, the client could request and receive different portions of media content from multiple other servers.

Further, the functions need not be performed in the disclosed order, although in some examples, an order may be preferred. Also, not all functions need to be performed to achieve the desired advantages of the disclosed system and method, and therefore not all functions are required.

While select examples of the disclosed system and method have been described, alterations and permutations of these examples will be apparent to those of ordinary skill in the art. Other changes, substitutions, and alterations are also possible without departing from the disclosed system and method in its broader aspects as set forth in the following claims.

What is claimed is:

1. A method comprising:
determining that a resume event occurred, wherein the resume event causes a client device to resume playout of personalized news programming after the client device plays out at least a portion of a first personalized news program;
in response to determining that the resume event occurred, determining a remainder duration representing a duration of the first personalized news program less an elapsed duration between (i) a start time when the client device initiated playout of the first personalized news program and (ii) a resume time when the resume event occurred;
using the determined remainder duration to generate a playlist of a second personalized news program having a duration that is less than the duration of the first personalized news program; and
transmitting the generated playlist to the client device.

2. The method of claim 1, further comprising transmitting to the client device a playlist of the first personalized news program.

3. The method of claim 1, wherein determining that the resume event occurred comprises receiving data indicating that the resume event occurred.

4. The method of claim 1, wherein determining the remainder duration comprises:
determining the duration of the first personalized news program;
determining the elapsed duration; and
determining the remainder duration as a difference between the determined duration of the first personalized news program and the determined elapsed duration.

5. The method of claim 1, wherein determining the remainder duration comprises:
determining the duration of the first personalized news program;
determining a pause duration between the resume time and a pause time of a pause event that causes the client device to pause playout of the first personalized news program;
determining a playout duration between the start time and the pause time; and
determining the remainder duration as the duration of the first personalized news program less a sum of (i) the determined playout duration and (ii) the determined pause duration.

6. The method of claim 1, wherein determining the remainder duration comprises:
determining the start time;
determining the resume time;
determining the elapsed duration as a difference between the determined resume time and the determined start time;
determining the duration of the first personalized news program; and
determining the remainder duration as a difference between the determined duration of the first personalized news program and the determined elapsed duration.

7. The method of claim 1, wherein determining the remainder duration comprises:
determining the start time;
determining a pause time of a pause event that causes the client device to pause playout of the first personalized news program;
determining a playout duration as a difference between the determined pause time and the determined start time;
determining the resume time;
determining the duration of the first personalized news program;
determining the pause duration as a difference between the determined resume time and the determined pause time; and
determining the remainder duration as the determined duration of the first personalized news program less a sum of (i) the determined playout duration and (ii) the determined pause duration.

8. A server device comprising:
a processor;
a communication interface; and
a non-transitory computer-readable storage medium having instructions stored thereon that when executed by the processor cause the server device to perform functions comprising:
determining that a resume event occurred, wherein the resume event causes a client device to resume playout of personalized news programming after the client device plays out at least a portion of a first personalized news program;
in response to determining that the resume event occurred, determining a remainder duration representing a duration of the first personalized news program less an elapsed duration between (i) a start time when the client device initiated playout of the first personalized news program and (ii) a resume time when the resume event occurred;
using the determined remainder duration to generate a playlist of a second personalized news program having a duration that is less than the duration of the first personalized news program; and
transmitting, via the communication interface, the generated playlist to the client device.

9. The server device of claim 8, wherein the functions further comprise transmitting to the client device a playlist of the first personalized news program.

10. The server device of claim 8, wherein determining that the resume event occurred comprises receiving, via the communication interface, data indicating that the resume event occurred.

11. The server device of claim 8, wherein determining the remainder duration comprises:
determining the duration of the first personalized news program;
determining the elapsed duration; and
determining the remainder duration as a difference between the determined duration of the first personalized news program and the determined elapsed duration.

12. The server device of claim 8, wherein determining the remainder duration comprises:
determining the duration of the first personalized news program;
determining a pause duration between the resume time and a pause time of a pause event that causes the client device to pause playout of the first personalized news program;
determining a playout duration between the start time and the pause time; and
determining the remainder duration as the duration of the first personalized news program less a sum of (i) the determined playout duration and (ii) the determined pause duration.

13. The server device of claim 8, wherein determining the remainder duration comprises:
determining the start time;
determining the resume time;
determining the elapsed duration as a difference between the determined resume time and the determined start time;
determining the duration of the first personalized news program; and
determining the remainder duration as a difference between the determined duration of the first personalized news program and the determined elapsed duration.

14. The server device of claim 8, wherein determining the remainder duration comprises:
determining the start time;
determining a pause time of a pause event that causes the client device to pause playout of the first personalized news program;
determining a playout duration as a difference between the determined pause time and the determined start time;
determining the resume time;
determining the duration of the first personalized news program;
determining the pause duration as a difference between the determined resume time and the determined pause time; and
determining the remainder duration as the determined duration of the first personalized news program less a sum of (i) the determined playout duration and (ii) the determined pause duration.

15. A non-transitory computer-readable storage medium having instructions stored thereon that when executed cause performance of functions comprising:
determining that a resume event occurred, wherein the resume event causes a client device to resume playout of personalized news programming after the client device plays out at least a portion of a first personalized news program;
in response to determining that the resume event occurred, determining a remainder duration representing a duration of the first personalized news program less an elapsed duration between (i) a start time when the client device initiated playout of the first personalized news program and (ii) a resume time when the resume event occurred;
using the determined remainder duration to generate a playlist of a second personalized news program having a duration that is less than the duration of the first personalized news program; and
transmitting the generated playlist to the client device.

16. The non-transitory computer-readable storage medium of claim 15, wherein determining that the resume event occurred comprises receiving data indicating that the resume event occurred.

17. The non-transitory computer-readable storage medium of claim 15, wherein determining the remainder duration comprises:
determining the duration of the first personalized news program;
determining the elapsed duration; and
determining the remainder duration as a difference between the determined duration of the first personalized news program and the determined elapsed duration.

18. The non-transitory computer-readable storage medium of claim 15, wherein determining the remainder duration comprises:
determining the duration of the first personalized news program;
determining a pause duration between the resume time and a pause time of a pause event that causes the client device to pause playout of the first personalized news program;
determining a playout duration between the start time and the pause time; and
determining the remainder duration as the duration of the first personalized news program less a sum of (i) the determined playout duration and (ii) the determined pause duration.

19. The non-transitory computer-readable storage medium of claim 15, wherein determining the remainder duration comprises:
determining the start time;
determining the resume time;
determining the elapsed duration as a difference between the determined resume time and the determined start time;
determining the duration of the first personalized news program; and
determining the remainder duration as a difference between the determined duration of the first personalized news program and the determined elapsed duration.

20. The non-transitory computer-readable storage medium of claim 15, wherein determining the remainder duration comprises:
determining the start time;
determining a pause time of a pause event that causes the client device to pause playout of the first personalized news program;
determining a playout duration as a difference between the determined pause time and the determined start time;
determining the resume time;
determining the duration of the first personalized news program;
determining the pause duration as a difference between the determined resume time and the determined pause time; and
determining the remainder duration as the determined duration of the first personalized news program less a sum of (i) the determined playout duration and (ii) the determined pause duration.
